(19) United States
(12) Patent Application Publication
(10) Pub. No.: US 2021/0107831 A1
(43) Pub. Date: Apr. 15, 2021

(54) Cement Waste Recycling Device and Method of Recycling Cement Waste

(71) Applicant: C2CA Technology B.V., Utrecht (NL)

(72) Inventors: Peter Rem, Utrecht (NL); Peter Berkhout, Utrecht (NL); Jaap Heijboer, Utrecht (NL); Harry Fase, Utrecht (NL)

(21) Appl. No.: 17/082,870

(22) Filed: Oct. 28, 2020

Related U.S. Application Data
(63) Continuation of application No. PCT/NL2019/050248, filed on Apr. 29, 2019.

(30) Foreign Application Priority Data
Apr. 30, 2018 (NL) 2020846

(51) Int. Cl. C04B 18/16; F27D 17/00; C04B 7/24; F27B 15/00; F27B 15/14; C04B 40/00

(52) U.S. Cl. CPC C04B 18/167; F27D 17/004; C04B 40/0046; F27B 15/006; F27B 15/14; C04B 7/246

(57) ABSTRACT

Devices and methods of recycling cement waste. A cement waste recycling device (1) comprising a heater (2) with an inlet (3) for cement waste and an outlet (4) for processed cement waste, wherein the heater (2) is configured for transporting cement waste in a cement waste transportation direction from the inlet (3) to the outlet (4) while transporting heated gas in countercurrent with the cement waste transportation direction.

### CROSS-REFERENCE TO RELATED APPLICATIONS

This application is a continuation application of International Patent Application No. PCT/NL2019/050248, titled “Cement Waste Recycling Device and Method of Recycling Cement Waste”, filed on Apr. 29, 2019, which claims priority to Netherlands Patent Application No. 2020846, titled “Cement Waste Recycling Device and Method of Recycling Cement Waste”, filed on Apr. 30, 2018, and the specification and claims thereof are incorporated herein by reference.

### FIELD OF THE INVENTION

Embodiments of the present invention relate to a cement waste recycling device and a method of recycling cement waste.

### BACKGROUND OF THE INVENTION

Cement's major constituents are calciumsilicates. After its use as a binder in concrete, by addition of water and gravel and/or sand, it is present in a hydrated form in a concentration of approximately 20% (w/w). If the hydrated calciumsilicates in waste concrete can be liberated from the gravel and/or sand, it can be heated again to produce new cement. The hydrated calciumsilicates can be liberated by heating the waste concrete to a temperature over 900° C. at which point it falls apart into gravel and/or sand and calciumsilicates. As the gravel and/or sand and the calciumsilicates are initially attached to one another, the gravel and/or sand act as a parasitic heat capacity.

German patent application DE 10 2006 049 836 A1 dis-closes a process for the production of a hydraulic binder from calcium silicates containing building rubble, wherein the building rubble is first reduced to particles with a size smaller than 10 mm, optionally enriching the binder phase of the building rubble by sieving or sorting, and subsequently heating the rubble at a temperature of 600° C. to 800° C. during 0.25 to 10 hours.

Obviously, such heating for extended periods requires a lot of energy, resulting in an industrially irrelevant process.

Alternatively, a two-step process can be applied wherein concrete waste is first heated to a lower temperature whereby the bonds between the gravel and/or sand and the calciumsilicates weaken. Thereafter, the heated concrete waste is milled and the bonds are broken.

A cement waste recycling device that makes use of such a two-step process is known from “H. Shima et al, An Advanced Concrete Recycling Technology and its Applicability Assessment through Input-Output Analysis, Journal of Advanced Concrete Technology, 2005”. Concrete rubble is crushed to a size under 50 mm and heated to 300° C. in a vertical kerosene fueled furnace. The heated concrete is thereafter sent to rubbing equipment.

In this batch-type process the cement waste is heated while it is stationary. This implies that heat is not distributed evenly throughout the cement waste resulting in temperature gradients and waste of energy.

The objective of the present invention is to provide a cement recycling device and a method for recycling cement which have a lower energy requirement as compared to the prior art devices and methods. Within the scope of this invention and for the avoidance of doubt it is remarked that cement waste includes concrete fines.

### SUMMARY OF THE INVENTION

In accordance with the present invention, there is provided a method of recycling cement waste, comprising contacting cement waste and heated gas with each other and obtaining heated cement waste having a temperature between 400° C. and 600° C., wherein the cement waste and the heated gas move in opposite directions to each other. This counter-current movement of cement waste and heated gas is advantageous because it promotes that the cement waste and the heated gas thoroughly mix with each other. This leads to an efficient transfer of heat from the heated gas to the cement waste, as the contact surfaces of both phases are as large as possible. Moreover, the countercurrent movement ensures that a temperature difference between both phases is as large as possible at every point in the device, resulting in a most optimal transfer of heat.

In accordance with the present invention, there is further provided a cement waste recycling device which is particularly suited for carrying out such a method, comprising a heater with an inlet for cement waste and an outlet for processed cement waste, the heater being configured for transporting cement waste in a cement waste transportation direction from the inlet to the outlet while transporting heated gas in counter-current with the cement waste transportation direction, wherein at least one screen is located between the inlet and the outlet of the heater and wherein at least part of the screen is vibratable. The screen between the inlet and the outlet of the heater acts to distribute the cement waste more evenly throughout the heater, thereby improving heat transfer from the heated gas phase to the cement waste phase. In addition, the screen acts as a barrier for the cement waste phase and slows down the transportation of the cement waste, resulting in a longer residence time of the cement waste in the heater and thus a better transfer of heat from the heated gas to the cement waste. The screen may be constructed from a sturdy material, such as steel or other metals or metal alloys.

At least part of the screen is vibratable. This prevents the screen from getting clogged and ensures no cement waste remains on top of the elongate bars that could be heated far above the desired temperature as the residence time of that particular cement waste would be much longer as other cement waste, resulting in unnecessary waste of energy.

### DETAILED DESCRIPTION OF THE INVENTION

In a preferred embodiment the screen may comprise a plurality of layers having multiple elongate bars, wherein the elongate bars within each layer are spaced apart and arranged approximately parallel to each other. An even distribution of parallel elongate bars ensures an even distribution of cement waste throughout the heater. By having gaps with equal distance between the bars, the velocity at which the cement waste passes through these gaps is more constant, resulting in a more evenly mixture of heated gas and cement waste.

In a preferred embodiment each of the plurality of layers may be arranged approximately perpendicular to the cement waste transportation direction. Such an arrangement improves the homogenous distribution of cement waste throughout the heater. A direction of each of the plurality of layers other than a direction perpendicular to the cement waste transportation direction would lead to a more uneven distribution of cement waste throughout the heater and the residence time of the cement waste would possess a larger variability.

In a preferred embodiment a first layer of the plurality of layers may be stacked in a staggered position on top of a second layer of the plurality of layers, wherein the elongate bars within the first layer are approximately parallel to the elongate bars within the second layer. A staggered configuration of layers of the screen increases the average distance a cement waste particle has to travel across the screen. Therefore, the average residence time is increased. The layers may be staggered such that the distances between a first bar in a first layer and two other bars in a second layer on top of said first layer are equal. In other words, the offset of a first layer in relation to a second layer on top of said first layer equals half the distance between the elongate bars within a layer.

In a preferred embodiment the elongate bars may be spaced apart at a regular first distance from each other within at least one layer of the plurality of layers. This ensures that a flux of cement waste through the heater from the inlet to the outlet is more constant in a cross-sectional plane perpendicular to the cement waste transportation direction, which leads to a more homogenous distribution of cement waste throughout the heater and thus a better transfer of heat from the heated gas to the cement waste.

In a preferred embodiment a width of each spacing between the elongate bars within at least one layer of the plurality of layers may be about 5-15 mm, preferably about 8-12 mm, most preferably approximately about 10 mm. The spacing between elongate bars in a layer of the screen is chosen dependent on the cement waste particle size distribution. When feeding the cement waste recycling device with cement waste having a size between about 0-4 mm, an optimal width of the spacing between elongate bars is found to be approximately about 10 mm. This spacing width represents a good trade-off between on the one hand slowing down the cement waste, thereby increasing the average residence time for efficient heat transfer, and on the other hand preventing the screen from getting clogged by larger cement waste particles. Cement waste may be milled until a size of the cement waste particles reaches about 0-4 mm. The cement waste material can be passed over a coarse protection screen, such as a 10 mm grizzly before being fed to the cement waste recycling device, to avoid accidental large particles blocking the internal space of the cement waste recycling device.

In a preferred embodiment each layer may be spaced apart at a regular distance from each other. This provides gaps between elongate bars within the screen that are very similar. Transporting cement waste across such a screen results in a more constant velocity and a homogenous distribution of the cement waste across the screen and therefore a more constant and predictable transfer of heat from the heated gas to the cement waste.

In a preferred embodiment the elongate bars may have an at least partly circular cross-section, such as an arc-like cross-section. An arc-like cross-section of an elongate bar is on the one hand efficient in deflecting cement waste towards either side of the elongate bar and on the other hand efficient in slowing down the cement waste. Another advantage is that an arc-like cross-section makes more efficient use of materials that constitute the elongate bars as compared to, for example, elongate bars having a circular or square cross-section. In other words they are cheaper.

In a preferred embodiment the elongate bars may have a radius of curvature of about 10-20 mm, preferably about 12.5 to 17.5 mm, and most preferably a radius of curvature of about 15 mm. This enables the elongate bars to have sufficient width to slow down the cement waste stream, while having a curvature that allows the cement waste to easily slide of to either side of the elongate bars, preventing the screen from becoming clogged with cement waste.

In a preferred embodiment at least part of the screen is vibratable at a frequency between about 20-30 Hz, preferably at about 25 Hz. This frequency ensures a good throughput of cement waste through the heater.

In a preferred embodiment at least part of the screen is vibratable in a vibration direction perpendicular to the cement waste transportation direction. Such a vibration direction is preferred, as it prevents the screen from getting clogged, while minimizing wear on the elongate bars by impinging cement waste.

In a preferred embodiment the vibration direction may be parallel to a longitudinal axis of the elongate bars. This vibration direction prevents cement waste particles from flying around inside the screen and thus minimizing wearing down the elongate bars. In addition, a steady flow of cement waste through the screen is realized.

In a preferred embodiment the cement waste recycling device may comprise a dampening device, preferably a bellow. This bellow acts as a vibration absorber and can be connected between the screen and the remainder of the cement waste recycling device to efficiently absorb the vibrations of the vibrating screen and prevent unwanted transmission of these vibrations to other stationary parts of the cement waste recycling device.

In a preferred embodiment the length of the screen in the cement transportation direction is approximately 1-2 m, preferably about 1.25-1.75 m, most preferably about 1.5 m. This length allows a residence time of the cement waste in the heater of over 30 seconds, which is sufficient to heat the cement waste up to about 520° C. The residence time can be adjusted by changing the size of the elongate bars in the screen, changing the distance between these elongate bars, changing the vibration direction and/or vibration frequency of the screen, changing a temperature of the heated gas introduced by the heater, changing the length and/or width of the screen, changing the number of layers inside the screen, and other variables.

In a preferred embodiment the cement waste recycling device comprises a first heater and a second heater, each having an inlet and an outlet, wherein the outlet of the first heater is connected to the inlet of the second heater. Such an arrangement is particularly advantageous, as it allows heating of the cement in the first heater, up to a temperature of approximately 520° C. to fracture the bonds between the sand/gravel and calcium silicates. Thereafter, in the second heater, the cement waste is cooled to a temperature below 250° C. and the recovered heat is directly fed into the first heater. By stacking both heaters above one another, a constant flow of cement waste and heated gas throughout the cement waste recycling device is ensured.

In a preferred embodiment the cement waste recycling device comprises a heated gas recycling conduit at one end connected near the outlet of a heater to the device and at another end thereof connected near the inlet of a heater to the device. The heated gas temperature near the inlet of the heater, or near the inlet of the first heater, if the cement waste recycling device comprises two heaters, is approximately 120° C. if the heated gas temperature near the outlet of the heater is approximately 600° C. with a countercurrent heated gas flow of approximately 1.3 kg/s for every kg/s throughput of cement waste. The exiting heated gas flow having a temperature of approximately 120° C. represents a significant amount of energy and as such, is a valuable source to recycle via a recycling conduit. Moreover, if the cement recycling device comprises two heaters, as mentioned above, heat exiting the inlet of the first heater can be guided to the outlet of the second heater, wherein the outlet of the first heater is connected to the inlet of the second heater. As such, cooled cement waste having a temperature below 250° C. exits the outlet of the second heater, via for example a rotary sluice. The calcium silicates contained within this cooled cement waste can thereafter be liberated from the cement waste by a suitable mechanical process, such as milling.

In a preferred embodiment the heated gas recycling conduit comprises a separator, preferably a cyclone. The exiting heated gas flow having a temperature of approximately 120° C. contains moisture, as well as a very fine fraction (250 micron) of the fine material in the cement waste. The flow of this very fine fraction represents about 10% of the total flow of fine material in the cement waste. As such, it is useful to remove this material from the exiting heated gas flow when this gas flow is recycled, to avoid accumulation of this material inside the cement waste recycling device. A cyclone can be used to remove this material from the exiting heated gas flow before this flow is recycled.

In a preferred embodiment the cement waste recycling device comprises a feeding unit connected to the inlet for feeding cement waste to the heater, wherein the feeding unit comprises a conveyor. Cement waste is relatively dense and a pilot cement waste recycling device is already capable of processing 3 tons of fine cement waste per hour. A conveyer enables the constant feeding of the cement waste recycling device, which is required to maintain its countercurrent operation.

In a preferred embodiment the conveyor is a screw conveyor. A screw conveyor can provide a constant flow of cement waste material and is suited to transport hard and heavy material. If desired, other conveyors can be used as well, such as a belt conveyor.

In a preferred embodiment the method may comprise moving the cement waste and the heated gas across a screen. The cement waste is dried while moving across the screen and is heated from ambient temperature up to a temperature of approximately 520° C. by contact with the heated gas whose temperature is lowered from approximately 600° C. to 120° C. The screen acts to slow down and disperse both the heated gas as well as the cement waste, to allow sufficient contact area and team for heat exchange.

In a preferred embodiment the method may comprise providing the screen with a plurality of layers having multiple elongate bars, wherein the elongate bars within each layer are spaced apart and arranged approximately parallel to each other. If the plurality of layers are arranged approximately perpendicular to the direction of movement of the cement waste and the heated gas, an optimal distribution of cement waste over the heater is achieved. Moreover, this allows the cement waste to be slowed down efficiently.

In a preferred embodiment the method may comprise stacking a first layer of the plurality of layers in a staggered position on top of a second layer of the plurality of layers, wherein the elongate bars within the first layer are approximately parallel to the elongate bars within the second layer. This method of stacking the layers within a screen results in a more efficient slowdown of the cement waste across the layers of the screen and enhances the homogenous distribution of cement waste throughout the screen.

In a preferred embodiment the method may comprise arranging the elongate bars spaced apart at a regular first distance from each other within at least one layer of the plurality of layers. This spacing apart can be such that a width of each spacing between the elongate bars is about 5-15 mm, preferably about 8-12 mm, most preferably approximately 10 mm.

In a preferred embodiment the method may additionally comprise arranging each layer such that each layer is spaced apart at a regular second distance from each other. Having even spacing of the elongate bars throughout the screen provides for an even and homogenous distribution of cement waste throughout the screen during operation of the cement waste recycling device.

In a preferred embodiment the method may comprise providing the elongate bars with an at least partly circular cross-section, such as an arc-like cross-section. Such an arc-like shape represents a good trade-off between slowing down the cement waste to promote efficient heat transfer, and preventing the screen from getting clogged. Arcs are additionally resilient and strong shapes, that are suited to withstand the impact of falling cement waste.

In a preferred embodiment the method may comprise providing the elongate bars with a radius of curvature of about 10-20 mm, preferably about 12.5 to 17.5 mm, and most preferably a radius of curvature of about 15 mm. As such the elongate bars are curved enough so that cement waste cannot accumulate on the elongate bars.

In a preferred embodiment the method may comprise providing that at least part of the screen is vibratable. Vibrational movements further enhance the fluid flow of cement waste throughout the screen and heater.

In a preferred embodiment the method may comprise providing that at least part of the screen is vibratable at a frequency between about 20-30 Hz, preferably at about 25 Hz.

In a preferred embodiment the method may comprise providing that at least part of the screen is vibratable in a vibration direction perpendicular to the direction of movement of the cement waste and the heated gas. This vibration direction makes sure that cement waste does not bounce off of the elongate bars as much as it would with another vibration direction.

In a preferred embodiment the vibration direction may be parallel to the elongate bars. In addition to being perpendicular to the cement waste transportation direction, this parallel direction further reduces the chance that cement waste bounces off of the elongate bars, and reduces wear of the elongate bars and the screen itself.

In a preferred embodiment the method may comprise providing the screen with a dampening device, preferably a bellow. This bellow, stops vibrational motion from being transmitted to stationary parts of the cement waste recycling device. Multiple dampening devices may be provided within the cement recycling device, depending on the amount of vibratable screens present.

In a preferred embodiment the method may comprise providing the screen with a length in the direction of movement of the cement waste and the heated gas of approximately 1-2 m, preferably about 1.25-1.75 m, most preferably about 1.5 m. This length allows sufficient residence time to heat the cement waste up to a temperature of about 520° C., although different lengths can be chosen dependent on the configuration of the screen and its purpose (heating or cooling).

In a preferred embodiment the method may comprise cooling the cement waste to a temperature between about 50° C. and about 200° C. after heating the cement waste to a temperature between about 400° C. and about 600° C. Cooling the cement waste after heating is an efficient way to reuse energy. As energy costs represent a large fraction of total costs required to recycle cement waste, regaining the energy spent on heating is very advantageous.

In a preferred embodiment the method may comprise recycling heated gas. Heated gas contains usable energy, and as such, recycling this gas results in a more energy efficient process, leading to lower operating costs. The heated gas stream can be captured at the inlet of a first heater and guided to an outlet of a second heater, wherein the first heater is stacked upon the second heater, and the outlet of the first heater is connected to the inlet of the second heater. The first heater as such effectively heats cement waste up to a temperature of about 450-550° C. and effectively cools heated gas down to a temperature of about 50-200° C. While in the second heater, the cement waste is cooled down below 250° C. and the recycled gas is heated to over 350° C. This very efficient arrangement of heaters leads to a cement waste recycling process that requires little energy as compared to prior art cement waste recycling processes.

In a preferred embodiment the method may comprise separating particles comprised in the heated gas with a separator, preferably a cyclone. If particles are removed from recycled gas, they cannot act as an energy sink anymore, further optimizing the overall energy efficiency of the cement waste recycling method.

In a preferred embodiment the method may comprise feeding the cement waste with a feeding unit before contacting the cement waste and the heated gas with each other, wherein the feeding unit comprises a conveyor. This results in a steady feed of cement waste, enabling effective heat transfer between the heated gas and the cement waste.

In a preferred embodiment the conveyor may be a screw conveyor. A screw conveyor is well equipped to transport hard and dense cement waste to an inlet of a heater at a steady flow rate, further optimizing heat transfer between the heated gas and the cement waste.

### SUMMARY OF THE FIGURES

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a front view of a cement recycling device in accordance with a preferred embodiment of the present invention;

FIG. 2 is a side view of the cement recycling device shown in FIG. 1;

FIG. 3 is a front view of a cement recycling device according to an embodiment of the present invention having two heaters stacked above each other, a cyclone and a heated gas recycling conduit; and

FIG. 4 is a side view of the cement recycling device shown in FIG. 3.

### DETAILED DESCRIPTION OF THE FIGURES

Whenever in the figures the same reference numerals are applied, these numerals refer to the same parts. In the figures, the following reference numerals are applied that denote the parts mentioned thereafter:
1 cement recycling device
2 heater
3 inlet
4 outlet
5 screen
6 layer
7 elongate bar
8 first distance
9 spacing
10 second distance
11 dampening device
12 heated gas recycling conduit
13 separator

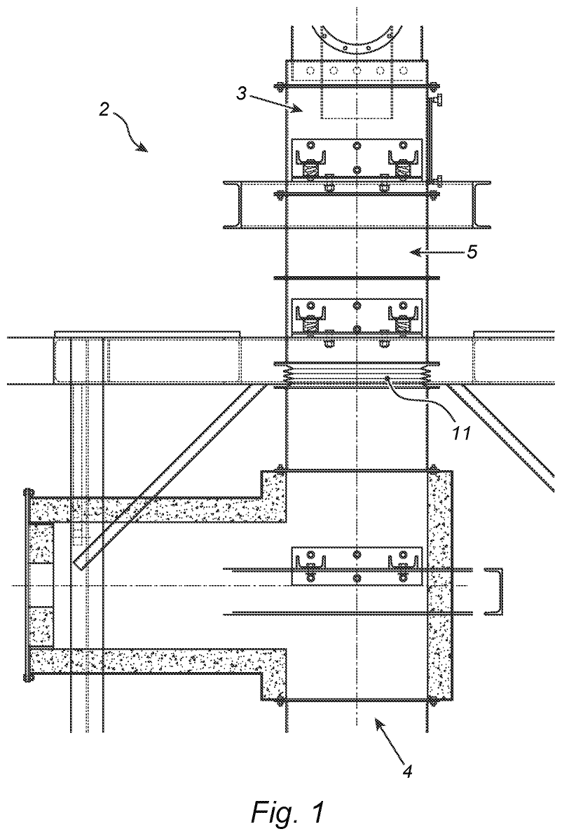

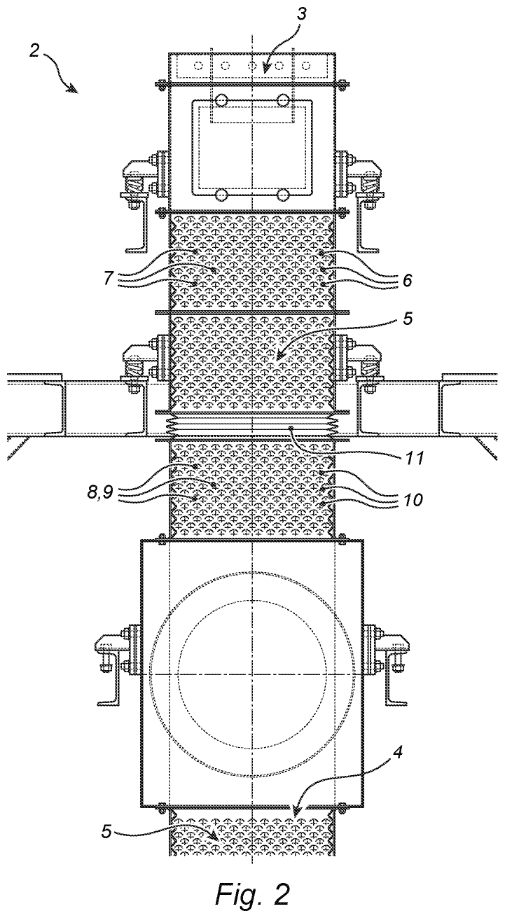

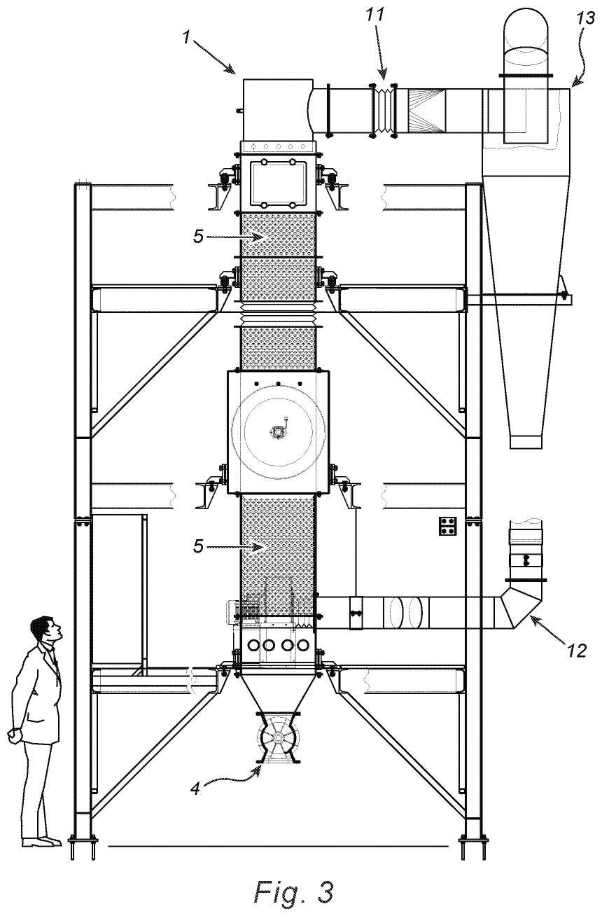

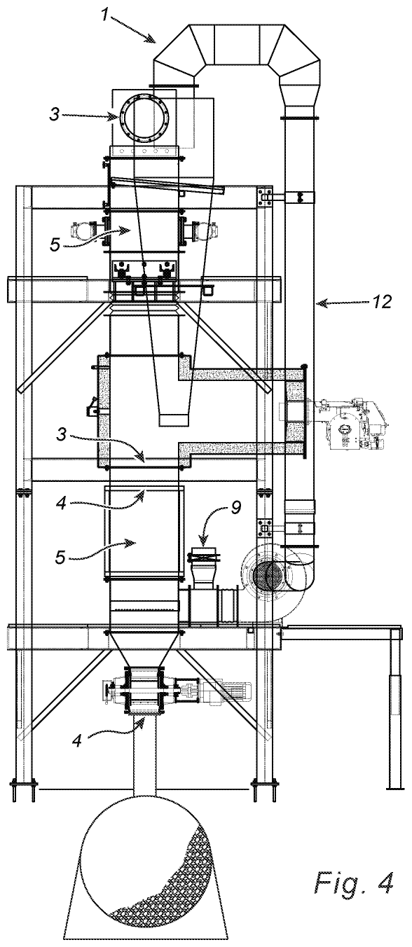

Referring to FIGS. 1-4, a cement recycling device 1, in accordance with a preferred embodiment of the present invention, comprises a heater 2 with an inlet 3 for cement waste and an outlet 4 for processed cement waste, wherein the heater 2 is configured for transporting cement waste in a cement waste transportation direction from the inlet 3 to the outlet 4 while transporting heated gas in countercurrent with the cement waste transportation direction.

At least one screen 5 may be located between the inlet 3 and the outlet 4 of the heater 2. This screen 5 may comprise a plurality of layers 6 having multiple elongate bars 7, wherein the elongate bars 7 within each layer 6 are spaced apart and arranged approximately parallel to each other.

Each of the plurality of layers 6 may be arranged approximately perpendicular to the cement waste transportation direction. A first layer 6 of the plurality of layers 6 may be stacked in a staggered position on top of a second layer 6 of the plurality of layers 6, wherein the elongate bars 7 within the first layer 6 are approximately parallel to the elongate bars 7 within the second layer 6.

The elongate bars 7 may be spaced apart at a regular first distance 8 from each other within at least one layer 6 of the plurality of layers 6. A width of each spacing 9 between the elongate bars within at least one layer 6 of the plurality of layers 6 may be 5-15 mm, preferably 8-12 mm, most preferably approximately 10 mm.

Each layer 6 may be spaced apart at a regular second distance 10 from each other. The elongate bars 7 may have an at least partly circular cross-section, such as an arc-like cross-section, having a radius of curvature of 10-20 mm, preferably 12.5 to 17.5 mm, and most preferably a radius of curvature of 15 mm.

At least part of the screen 5 may be vibratable at a frequency between 20-30 Hz, preferably at about 25 Hz. The direction of this vibration may be perpendicular to the cement waste transportation direction or parallel to a longitudinal axis of the elongate bars 7.

The cement waste recycling device 1 may further comprise a dampening device 11, preferably a bellow.

The length of the screen in the cement transportation direction may be approximately 1-2 m, preferably 1.25-1.75 m, most preferably about 1.5 m.

The cement waste recycling device 1 may comprise a first heater 2 and a second heater 2, each having an inlet 3 and an outlet 4, wherein the outlet 4 of the first heater 2 is connected to the inlet 3 of the second heater 2. Heat can be recycled in the cement waste recycling device 1 which may comprise a heated gas recycling conduit 12 at one end connected near the outlet 4 of a heater 2 to the device 1 and at another end thereof connected near the inlet 3 of a heater 2 to the device 1. This heated gas recycling conduit 12 may comprise a separator 13, preferably a cyclone.

The cement waste recycling device 1 may comprise a feeding unit connected to the inlet 3 for feeding cement waste to the heater 2, wherein the feeding unit comprises a conveyor. This conveyor can be a screw conveyor.

Although the invention has been discussed in the foregoing with reference to an exemplary embodiment of the device and method of the invention, the invention is not restricted to this particular embodiment which can be varied in many ways without departing from the invention. The discussed exemplary embodiment shall therefore not be used to construe the appended claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Note that in the specification and claims, “about” or “approximately” means within twenty percent (20%) of the numerical amount cited.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

1. A cement waste recycling device comprising:
a heater with an inlet for cement waste and an outlet for processed cement waste, wherein the heater is configured for transporting cement waste in a cement waste transportation direction from the inlet to the outlet while transporting heated gas in counter-current with the cement waste transportation direction, and wherein at least one screen is located between the inlet and the outlet of the heater, and wherein at least part of the screen is vibratable.

2. The cement waste recycling device according to claim 1, wherein the screen comprises a plurality of layers having multiple elongate bars, wherein the elongate bars within each layer are spaced apart and arranged approximately parallel to each other.

3. The cement waste recycling device according to claim 2, wherein each of the plurality of layers is arranged approximately perpendicular to the cement waste transportation direction.

4. The cement waste recycling device according to claim 2, wherein a first layer of the plurality of layers is stacked in a staggered position on top of a second layer of the plurality of layers, wherein the elongate bars within the first layer are approximately parallel to the elongate bars within the second layer.

5. The cement waste recycling device according to claim 2, wherein the elongate bars are spaced apart at a regular first distance from each other within at least one layer of the plurality of layers.

6. The cement waste recycling device according to claim 2, wherein a width of each spacing between the elongate bars within at least one layer of the plurality of layers is between about 5 mm and about 15 mm.

7. The cement waste recycling device according to claim 2, wherein each layer is spaced apart at a regular second distance from each other.

8. The cement waste recycling device according to claim 2, wherein the elongate bars have an at least partly circular cross-section.

9. The cement waste recycling device according to claim 2, wherein the elongate bars have a radius of curvature of between about 10 mm and about 20 mm.

10. The cement waste recycling device according to claim 9, wherein at least part of the screen is vibratable at a frequency between about 20 Hz and about 30 Hz.

11. The cement waste recycling device according to claim 9, wherein at least part of the screen is vibratable in a vibration direction perpendicular to the cement waste transportation direction.

12. The cement waste recycling device according to claim 11, wherein the vibration direction is parallel to a longitudinal axis of the elongate bars.

13. The cement waste recycling device according to claim 9, wherein the cement waste recycling device comprises a dampening device.

14. The cement waste recycling device according to claim 1, wherein the length of the screen in the cement transportation direction is between about 1 m and about 2 m.

15. The cement waste recycling device according to claim 1, wherein the cement waste recycling device comprises a first heater and a second heater, each having an inlet and an outlet, wherein the outlet of the first heater is connected to the inlet of the second heater.

16. The cement waste recycling device according to claim 1, wherein the cement waste recycling device comprises a heated gas recycling conduit at one end connected near the outlet of a heater to the device and at another end thereof connected near the inlet of a heater to the device.

17. The cement waste recycling device according to claim 12, wherein the heated gas recycling conduit comprises a separator.

18. The cement waste recycling device according to claim 1, wherein the cement waste recycling device comprises a feeding unit connected to the inlet for feeding cement waste to the heater, and wherein the feeding unit comprises a conveyor.

19. The cement waste recycling device according to claim 18, wherein the conveyor is a screw conveyor.

20. A method of recycling cement waste, the method comprising:
contacting cement waste and heated gas with each other; and
heating the cement waste to a temperature between 400° C. and 600° C.;
causing the cement waste and the heated gas to move in opposite directions with respect to each other.

21. The method according to claim 20, wherein the method further comprises moving the cement waste and the heated gas across a screen.

22. The method according to claim 21, wherein the screen comprises a plurality of layers having multiple elongate bars, wherein the elongate bars within each layer are spaced apart and arranged approximately parallel to each other.

23. The method according to claim 22, wherein the method comprises arranging each of the plurality of layers approximately perpendicular to the direction of movement of the cement waste and the heated gas.

24. The method according to claim 22, wherein the plurality of layers comprises a first layer and a second layer, and the first layer of the plurality of layers is in a staggered position on top of the second layer of the plurality of layers, and wherein the elongate bars within the first layer are approximately parallel to the elongate bars within the second layer.

25. The method according to claim 22, wherein the method comprises arranging the elongate bars spaced apart at a regular first distance from each other within at least one layer of the plurality of layers.

26. The method according to claim 22, wherein the method comprises arranging the elongate bars within the plurality of layers such that a width of each spacing between the elongate bars is between about 5 mm and about 15 mm.

27. The method according to claim 22, wherein the method comprises arranging each layer such that each layer is spaced apart at a regular second distance from each other.

28. The method according to claim 22, wherein the elongate bars comprise an at least partly circular cross-section.

29. The method according to claim 22, wherein the method comprises providing the elongate bars with a radius of curvature of between about 10 mm and about 20 mm.

30. The method according to claim 22, wherein at least part of the screen is vibratable.

31. The method according to claim 30, wherein at least part of the screen is vibratable at a frequency between about 20 Hz and about 30 Hz.

32. The method according to claim 30, wherein the at least part of the screen is vibratable in a vibration direction perpendicular to the direction of movement of the cement waste and the heated gas.

33. The method according to claim 32, wherein the vibration direction is parallel to the elongate bars.

34. The method according to claim 30, wherein the screen comprises a dampening device.

35. The method according to claim 21, wherein the screen comprises a length in the direction of movement of the cement waste and the heated gas of between about 1 m and about 2 m.

36. The method according to claim 20, wherein the method further comprises cooling the cement waste to a temperature between 50° C. and 200° C. after heating the cement waste to a temperature between about 400° C. and about 600° C.

37. The method according to claim 20, wherein the method further comprises recycling heated gas.

38. The method according to claim 37, wherein the method further comprises separating particles in the heated gas with a separator.

39. The method according to claim 20, wherein the method further comprises feeding the cement waste with a feeding unit before contacting the cement waste and the heated gas with each other, wherein the feeding unit comprises a conveyor.

40. The method according to claim 39, wherein the conveyor is provided as a screw conveyor.
